(19) United States
(12) Patent Application Publication
(10) Pub. No.: US 2024/0013939 A1
(43) Pub. Date: Jan. 11, 2024

(54) Modular Space Reactor Systems and Methods of Use

(71) Applicant: Atomos Nuclear and Space Corporation, Denver, CO (US)

(72) Inventor: Lucas Brady Beveridge, Denver, CO (US)

(73) Assignee: Atomos Nuclear and Space Corporation, Denver, CO (US)

(21) Appl. No.: 18/123,205

(22) Filed: Mar. 17, 2023

Related U.S. Application Data
(60) Provisional application No. 63/321,690, filed on Mar. 19, 2022.

(51) Int. Cl. G21C 21/00

(52) U.S. Cl. CPC G21C 21/00

(57) ABSTRACT

A modular space reactor includes a plurality of sections, each section containing a component of an assembled reactor. Each section contains contents configured to be unable to sustain a fission chain reaction as an individual section and is configured to be separately launched into space from each other section. The sections are configured for assembly in space to form the assembled reactor configured for sustaining an active fission chain reaction only when all of the sections are assembled together. In embodiments, contents of a section include at least one of fissile fuel, reactivity control devices, neutron reflectors, neutron moderators, radiation shielding mechanisms, cooling systems, power conversion systems. In embodiments, the sections are further configured for disassembly in space for being separable for at least one of refueling, decommissioning, and disposal of the system so disassembled. In embodiments, the modular space reactor is configured to sustain radioactive chain reactions when assembled.

### REFERENCE TO RELATED APPLICATIONS

The present application claims the benefit of U.S. Provisional Pat. App. No. 63/321,690, filed 2022 Mar. 19 and titled “Space Reactor Systems and Methods of Use.” The above referenced application is incorporated hereby in its entirety by reference.

### FIELD OF THE INVENTION

Aspects of the present disclosure generally relate to a space system and, more specifically, to a space reactor system configured to be safely launched into space and method of use thereof.

### DESCRIPTION OF RELATED ART

Although the regulations for launching space-nuclear systems has technically changed in the last several years due to a pair of presidential memoranda (President of the United States, Presidential Memorandum on Launch of Spacecraft Containing Space Nuclear Systems, Washington, D.C.: White House, 2019; and President of the United States, Memorandum on the National Strategy for Space Nuclear Power and Propulsion (Space Policy Directive-6), Washington, D.C.: White House, 2020), there is a great deal of skepticism and hesitancy in the nuclear industry with regards to launching nuclear reactors into space.

The new directives break nuclear system launches into three tiers (See the 2019 Presidential Memorandum referenced above). The first tier applies primarily to radioisotope systems that cannot go critical (in the sense of self-sustaining fission reactions). This first tier refers to International Atomic Energy Agency (IAEA) safety requirements (See International Atomic Energy Agency, Regulations for the Safe Transport of Radioactive Material, 2018 Edition, International Atomic Energy Agency, 2018), namely:
“Tier I shall apply to launches of spacecraft containing radioactive sources of total quantities up to and including 100,000 times the A2 value listed in Table 2 of the International Atomic Energy Agency's Specific Safety Requirements No. SSR-6 (Rev. 1), Regulations for the Safe Transport of Radioactive Material, 2018 Edition. For Federal Government missions in Tier I, the head of the sponsoring agency shall be the launch authorization authority.” [Note: A2 is defined by IAEA as the activity value of radioactive material, other than special form radioactive material, that is listed in Table 2 of the IAEA 2018 reference cited above, and is used to determine the activity limits for the IAEA safety requirements.]
Tier II applies to fission systems (i.e., reactors), with uranium enrichments below 20% (low enriched uranium, LEU) or radioactivity higher than the level specified in Tier I and requires additional safety reviews. Tier III applies to any system with fissionable fuel other than LEU, or higher radioactivity materials. Tier III has higher levels of security and safety requirements than the lower tiers.

Many nuclear propulsion concepts have been proposed over the decades, using the heat from a reactor or radioisotope to either generate electricity for an electric thruster, or directly heat a propellant. In the case of the latter, the specific impulse is severely limited by the temperature of the materials and lifetime is limited by the corrosive nature of the low molecular weight propellants (such as hydrogen). In the case of the former, the reactor requires a heavy power conversion system such as Brayton or Rankine conversion with complex and expensive components that are difficult to make reliable enough for a spacecraft. Additionally, the nuclear-electric system requires a massive heat rejection system to dump waste heat, and heavy shielding to protect the payload from gamma-rays and neutrons.

While radioisotope thrusters have also been proposed, to date they require isotopes produced on Earth and integrated with a thruster during manufacturing. This conventional approach restricts the options to isotopes that are longer lived that may be handled and launched before expiration (such as Pu-238, or Po-210). However, longer lived isotopes have very low activity (low power density) and, due to practical and safety limitations, the thrusters are quite small and low thrust. Only one known thruster concept has a relatively high-power density due its use of a shorter-lived alpha emitter such as Po-210 to generate a high-voltage potential between electrodes in an electrostatic thruster (See U.S. Pat. No. 3,184,915 to Low et al, incorporated by reference in entirety for all purposes).

Thus, a space reactor system and use method to overcome the above limitations would be desirable.

### SUMMARY OF THE INVENTION

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In an embodiment, a modular space reactor includes a plurality of sections, each section containing a component of an assembled reactor. Each section contains contents configured to be unable to sustain a fission chain reaction as an individual section and is configured to be separately launched into space from each other section. The sections are configured for assembly in space to form the assembled reactor configured for sustaining an active fission chain reaction only when all of the sections are assembled together.

In embodiments, contents of at least one section include at least one of fissile fuel, reactivity control devices, neutron reflectors, neutron moderators, radiation shielding mechanisms, cooling systems, power conversion systems. In embodiments, the sections are further configured for disassembly in space for being separable for at least one of refueling, decommissioning, and disposal of the system so disassembled.

In accordance with another embodiment, a method for providing a space reactor includes designing a modular space reactor including a plurality of sections, fabricating the plurality of sections, and separately launching into space each one of the plurality of sections from each other one of the plurality of sections. The method further includes assembling the plurality of sections in space to form the space reactor, and activating the space reactor so assembled. Each one of the plurality of sections is configured to be unable to individually sustain a fission chain reaction, and the space reactor is configured to be capable of sustaining an active fission chain reaction only when all of the plurality of sections are assembled together.

In certain embodiments, assembling the plurality of sections in space includes performing at least one of automatic rendezvous, manual rendezvous, and proximity operations to bring together the plurality of sections.

In other embodiments, assembling the plurality of sections in space includes at least one of docking, robotic assembly, manual assembly by remote control from astronauts in space, and manual assembly physically by astronauts in space.

In a further embodiment, assembling the plurality of sections in space includes coupling together at least one of electrical harnesses, fluid lines, gas connections, heat transfer structures, and additional equipment, devices, and structures associated with the reactor system.

In accordance with another embodiment, a modular space reactor includes a plurality of sections, each section containing a component of an assembled reactor. Each one of the plurality of sections contains contents configured to be unable to sustain a radioactive chain reaction as an individual section, and each one of the plurality of sections is configured to be separately launched into space from each other one of the plurality of sections. In embodiments, the plurality of sections are configured for assembly in space to form the assembled reactor, and the assembled reactor is configured for sustaining an active radioactive chain reaction only when all of the plurality of sections are assembled together.

In certain embodiments, contents of at least one of the plurality of sections include at least one of radioactive isotopes, reactivity control devices, neutron reflectors, neutron moderators, radiation shielding mechanisms, cooling systems, power conversion systems.

In embodiments, the plurality of sections are further configured for disassembly in space for being separable for at least one of refueling, decommissioning, and disposal of the system so disassembled.

In a further embodiment, a method for providing a space reactor includes designing a modular space reactor including a plurality of sections, fabricating the plurality of sections, and separately launching into space each one of the plurality of sections from each other one of the plurality of sections. The method further includes assembling the plurality of sections in space to form the space reactor, and activating the space reactor so assembled. In embodiments, each one of the plurality of sections is configured to be unable to individually sustain a radioactive chain reaction, and the space reactor is configured to be capable of sustaining an active radioactive chain reaction only when all of the plurality of sections are assembled together.

In certain embodiments, assembling the plurality of sections in space includes performing at least one of automatic rendezvous, manual rendezvous, and proximity operations to bring together the plurality of sections. In other embodiments, assembling the plurality of sections in space includes at least one of docking, robotic assembly, manual assembly by remote control from astronauts in space, and manual assembly physically by astronauts in space. In further embodiments, assembling the plurality of sections in space includes coupling together at least one of electrical harnesses, fluid lines, gas connections, heat transfer structures, and additional equipment, devices, and structures associated with the reactor system.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 illustrates a configuration of a modular space reactor, in accordance with an embodiment.

FIG. 2 illustrates an alternative configuration of a modular space reactor, in accordance with an embodiment.

FIG. 3 illustrates another configuration of a modular space reactor, in accordance with an embodiment.

FIG. 4 illustrates a further configuration of a modular space reactor, in accordance with an embodiment.

FIG. 5 illustrates still another configuration of a modular space reactor, in accordance with an embodiment.

FIG. 6 illustrates a sequence of assembling a modular space reactor, in accordance with an embodiment.

FIGS. 7A-7E illustrate a sequence of capturing a component of a modular space reactor by an orbital transfer vehicle, in accordance with an embodiment.

FIG. 8 shows a flow chart illustrating a process of using a modular space reactor, in accordance with an embodiment.

FIG. 9 shows an exemplary configuration of the docking of two reactor portions, in accordance with an embodiment.

FIG. 10 shows an alternative configuration of a modular space reactor, in accordance with an embodiment.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

### DETAILED DESCRIPTION OF THE INVENTION

The embodiments described in the present disclosure overcomes the significant limitations of conventional nuclear propulsion concepts to include conventional radioisotope thruster concepts operated in space.

In an embodiment, two or more fueled disc sections are launched separately, then coupled end-to end (axially) in space. Two or more disc-sections are required for the reactor to go critical (i.e., sustain a fission chain reaction). One or more sections may contain portions of the reactor control system and instrumentation. Each section is designed so that it cannot (under any plausible scenario or launch accident) sustain a fission chain reaction.

It is recognized herein that the A2 values from Table 2 in the IAEA 2018 publication cited above for uranium 235, 238 and LEU are unlimited. This requirement plus the requirements for Tier I suggest that small amounts of fissionable fuel could be launched (i.e., in quantities small enough that it is physically impossible to achieve criticality) under Tier I. Therefore, in accordance with certain embodiments, a space nuclear reactor may be launched in multiple pieces on separate launch vehicles and assembled in space (e.g., in a stable nuclear-safe orbit) while satisfying the requirements of Tier I and avoid incurring the additional safety reviews of Tier II. Certain embodiments of this concept are described immediately hereinafter.

Examples of possible reactor launch configurations are further described below. An important feature is that the individual reactor sections/fuel loads are designed so that they cannot sustain a fission chain reaction under a variety of anticipated plausible scenarios, such as submersion in sea water (which would moderate neutrons), compression from a launch explosion (which increases fuel density), or other possible launch accident. This objective may be accomplished done by reducing the quantity of fissile material in any single launch so that achieving a critical mass would be essentially impossible. Reducing the fuel quantity per launch also reduces the risk of the fuel container(s) failing in a launch accident, since each container(s) may be made more robust, as well as the amount of radioactive material that can spread into the environment in case of a catastrophic failure. To remain within the requirements of Tier I, the uranium fuel must also be low-enriched (e.g., below 20% enrichment).

Various embodiments described herein involve the separate launch of two or more separate sections/fuel loads (e.g., on separate launch vehicles) and combined in space. Many solid-fuel particles or fuel elements (for example, fuel pebbles for a pebble-bed reactor), may be delivered to the reactor in space in multiple loads launched separately from one another, such that each load by itself cannot sustain a fission chain reaction under any plausible scenario or launch accident. The fuel elements may be placed in the reactor using a variety of coupling mechanisms. When the reactor contains enough fuel, it can go critical. Several examples of modular space reactors are illustrated below.

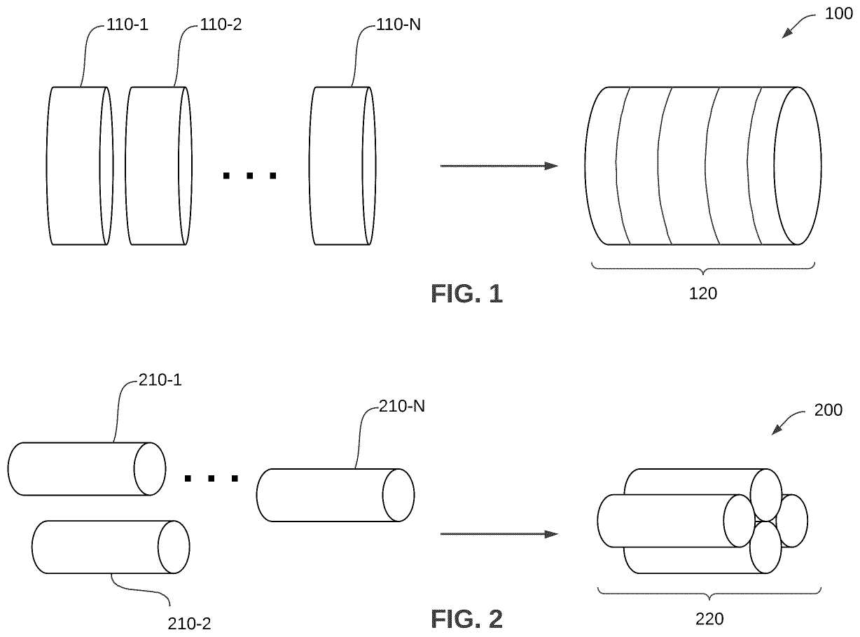

FIG. 1 illustrates a configuration of a modular space reactor, in accordance with an embodiment. As shown in FIG. 1, a schematic 100 shows two or more disc sections 110-1, 110-2, . . . 110-N. Each one of disc sections may include, for example, liquid, gas, or solid fuel, a reactor sub-core, containment chambers, reactor control system, mechanical and/or electrical control instrumentation, attachment and interfacing hardware, and other components necessary to be combined together to form a reactor 120 when coupled end-to-end (i.e., axially) in space. In certain embodiments, each one of the disc sections only contains a portion of the reactor such that any single section cannot sustain a fission chain reaction. Only when two or more disc sections are combined together to form reactor 120 can the combined system (i.e., reactor 120) go critical and sustain a fission chain reaction suitable for providing power.

In embodiments, each one of disc sections is launched separately in a launch vehicle, such as a rocket (not shown in FIG. 1). Two or more disc sections, in combinations that do not initiate or sustain a fission chain reaction, may be launched together in a single launch vehicle, provided the particular combination cannot function as a standalone reactor. In other words, upon launch, each one of the disc sections, or combination of disc sections, is inert and cannot go critical. Only when the disc sections are assembled axially in space can the assembly of disc sections form an operational reactor.

The variety of control elements and instrumentation (e.g., control rods, drums, discs, and/or other reactivity control mechanisms) may be split among different disc sections, or contained within one or a few of the disc sections. Similarly, any cooling system components (e.g., pumps, heat pipes, channels for fluid coolant, and/or other heat transfer devices) may be split among the disc sections or contained within one or a few of the disc sections. Conversely, any control or coolant devices may be separate from the disc sections, and only added during or after assembly. Other components or systems used in association with reactors, such as fissile fuel, reactivity control devices, neutron reflectors, neutron moderators, radiation shielding mechanisms, cooling systems, power conversion systems (or subsystems that may be disposed on different disc sections then assembled) may also be launched within one or a few of the disc sections then assembled together in space, and such configurations are considered to be a part of the present disclosure. Assembly of the disc sections may be performed autonomously (e.g., in a self-assembly manner, using pre-programmed autonomous means, or by robots or the like), by remote control by humans in space or on the ground, or manually by humans in space (e.g., astronauts). The assembly process may be performed using, for example, rendezvous and docking procedures or by other mechanisms for safely and securely fastening together components in space. For instance, the axial assembly configuration illustrated in FIG. 1 follows a well-established process of rendezvous and docking used in space, although not for reactor components. It is noted that, in the disc sections assembly configuration of FIG. 1, the fuel assemblies with the reactor segments are quite short in length, thus the coolant flow design in the assembled reactor should take the dimensions of the fuel assemblies into account to provide sufficient cooling.

The disc sections may be assembled using a variety of mechanisms, such as clamps, coupling brackets, magnetic couplers, and/or mechanical latches (not shown). Each disc section may be formed of known space-worthy materials using techniques known in the art. However, each disc section is configured to securely contain a portion of the overall reactor system in a manner that prevents any single disc section from nuclear reactions without being properly coupled with at least one other disc section. Mechanical and/or electrical safety systems may be implemented on one or more disc sections to prevent unwanted fission reactions from occurring, either during transport of a disc section or of the assembled reactor. The assembly of the disc sections into a complete reactor may be performed, for example, using an external robotic assembly (as will be discussed below) or integrated or internal components provided with one or more of the disc sections, such as robotic arms, propulsion systems, navigation and rendezvous systems, remote control systems, and proximity operations systems. Reactor 120 may include additional features such as, not limited to, a containment shell or bracket to help contain or lock together the assembled disc sections.

It is noted that, rather than fissile fuels, the modular space reactor of FIG. 1 may be configured to function as a reactor using radioactive isotopes. In such a case, each one of the disc sections may contain a sufficiently small amount of radioactive isotopes so as to be unable to sustain a reactive chain reaction as an individual section. Further, each one of the disc sections may contain only a small amount of radioactive isotopes with sufficiently secure containment mechanisms, such as shields and container wall construction, such that only low or no levels of harmful radioactivity may be transmitted outside of each disc section, thus allowing safe transport and launch of the disc section.

FIG. 2 illustrates an alternative configuration of a modular space reactor, in accordance with an embodiment. As shown in FIG. 2, a schematic 200 shows two or more cylindrical sections 210-1, 210-2, . . . 210-N, each cylindrical section (or combinations of two or more cylindrical sections that do not combine to go critical in combination with each other until the entire system is assembled together) being launched separately then assembled in space into a reactor 220. In an example, the cylindrical sections may be coupled side-by-side (e.g., radially) in space using methods similar to those discussed above with respect to FIG. 1. For instance, like the disc sections described above with respect to FIG. 1, each one of the cylindrical sections may contain a portion of the reactor such that any single cylindrical section is not capable of supporting a fission reaction. Only upon assembly of the entire structure of reactor 220 will the system function to produce an energy output.

Again, the various components of the overall reactor may be split among multiple cylindrical sections or multiple components may be contained within a single section, provided the components contained within the single section are not sufficiently reactive to produce a fission chain reaction. While the radial assembly of the cylindrical sections, as shown in FIG. 2, is more complex to implement than the axial docking of FIG. 1, such an assembly process may still be performed using, for example, robotic assembly. In certain embodiments, at least some of the cylindrical sections may each contain a fuel assembly and an independent cooling system therein.

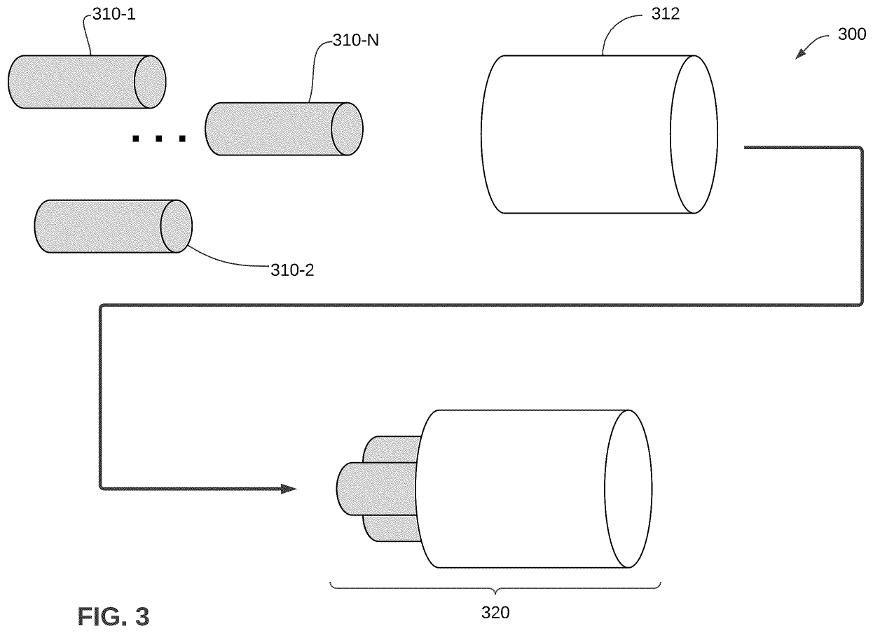

FIG. 3 illustrates another configuration of a modular space reactor, in accordance with an embodiment. As shown in FIG. 3, a plurality of fuel assemblies 310-1, 310-2, . . . 310-N are separately launched from one another and a reactor housing and control system 312. Once in space, the fuel assemblies and the reactor housing and control system may be assembled to form a reactor 320. In an example, each one of the plurality of fuel assemblies contains less than sufficient fuel (e.g., liquid, gas, or solid fuel) to support a fission reaction; that is, only when two or more of the fuel assemblies is inserted into the reactor housing and control system will the combination operate as a reactor. In embodiments, multiple components of reactor 320 (e.g., reactor housing and control system 312 with one or two of the fuel assemblies) may be launched together, so long as the sum of the fuel assemblies is not enough to sustain a fission chain reaction. While FIG. 3 shows the fuel assemblies being inserted axially into reactor housing and control system 312, the fuel assemblies may also be coupled with the reactor housing in a radial manner or assembled with interlocking geometry. In certain embodiments, the configuration of FIG. 3 may exhibit a combination of the advantages provided by the configurations in FIGS. 1 and 2, as the configuration of FIG. 3 may be implemented by well-established axial docking procedures and/or robotic assembly, and the reactor housing may include a shared cooling system for multiple fuel assemblies inserted therein.

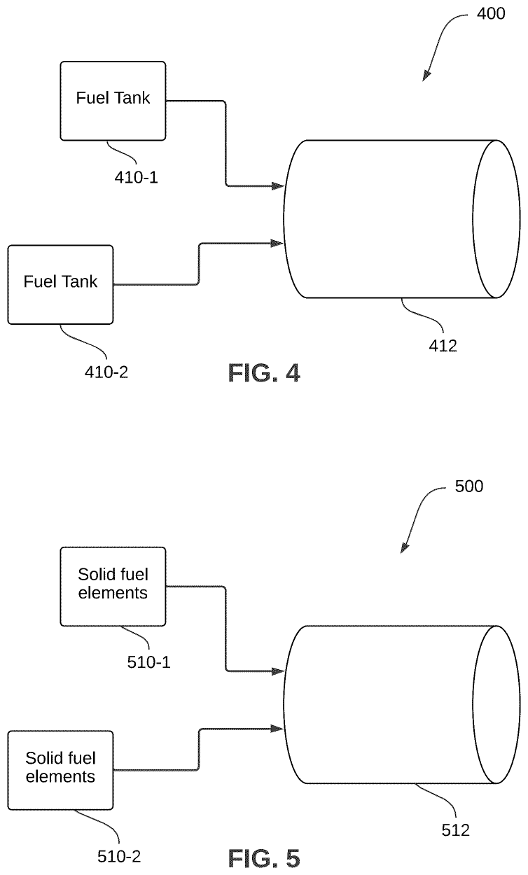

FIGS. 4 and 5 illustrate additional configurations of a modular space reactor, in accordance with embodiments. For instance, FIG. 4 illustrates a reactor 400 showing fuel tanks 410-1 and 410-2 of a fluid fuel (e.g., in liquid or gas form, such as a molten salt solution with uranium fuel dissolved therein, an aqueous uranium solution, or a uranium-bearing gas, such as uranium hexafluoride or uranium tetra fluoride). Each one of fuel tanks 410-1 and 410-2 contains less than sufficient fuel to sustain a fission chain reaction. Launched separately, fuel tanks 410-1 and 410-2 and a reactor housing and control system 412 may be assembled in space to form reactor 400 as discussed above with respect to FIGS. 1-3, and only then will the system be used for power generation. In embodiments, the control and instrumentation (i.e., any component of the overall reactor system, other than fuel) may be contained within reactor housing and control system 412. In certain embodiments, the reactor housing may be launched in sections with a portion of the fuel enclosed therein (i.e., at fuel amounts less than the amount necessary for a fission or radioactive chain reaction), then assembled in space. In such embodiments, the fuel tanks need not be separately inserted into the reactor housing.

Each fuel tank is designed such that a single fuel tank is not capable of sustaining a fission chain reaction under a variety of plausible scenarios or launch accident. The fluid fuel may be delivered and transferred to reactor housing and control system 412 in space. When the reactor contains enough fuel, it can go critical. In embodiments, the fluid fuel may not be solid when launched, then be converted into a fluid form when transferred to the reactor vessel in space. In some cases, the fluid fuel may be melted or vaporized prior to transfer. Each fuel tank may be sized such that a single fuel tank cannot go critical on its own under a variety of anticipated conditions.

While two fuel tanks are shown in FIG. 4, additional fuel tanks may be separately launched from and connected with reactor housing and control system 412. The fuel tanks may be coupled with the reactor housing and control system using a variety of coupling systems, including mechanical brackets and other known coupling mechanisms that are considered a part of the present disclosure.

Similarly, FIG. 5 illustrates a reactor 500 with solid fuel elements 510-1 and 510-2 separately launched from and connected with reactor housing 512 in space. For example, solid fuel particles (e.g., pebbles or kernels) or fuel elements (e.g., fuel pebbles for a pebble-bed reactor) may be delivered to a reactor in space in multiple loads launched separately from one another. In this way, each load by itself cannot sustain a fission chain reaction under any plausible scenario or launch accident. In certain embodiments, the fuel particles may be pre-loaded into reactor sections, as long as the amount of fuel contained in each separately launched section is not sufficient to sustain a fission chain reaction.

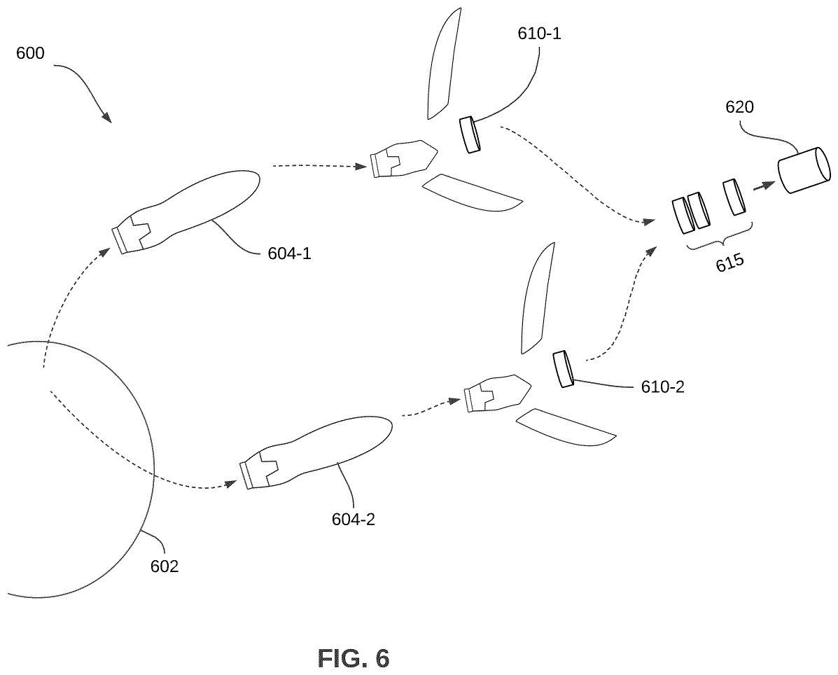

FIG. 6 illustrates a sequence of assembling a modular space reactor, in accordance with an embodiment. As shown in FIG. 6, a schematic 600 illustrates the launching of rockets containing portions of a reactor from an origination location 602 (e.g., Earth or other planets of the solar system). For instance, two rockets 604-1 and 604-2, each containing a disc section may be launched separately. Upon reaching a desired location, such as an intended orbit, rockets 604-1 and 604-2 release disc sections 610-1 and 610-2, respectively. Then, when all of the disc sections (shown collectively as a disc stack 615) are brought together in space, they may be assembled into a reactor 620.

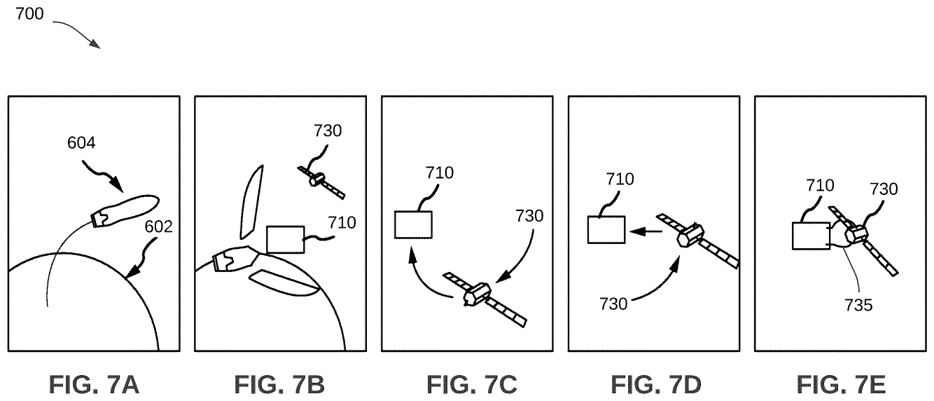

FIGS. 7A-7E illustrate a sequence of capturing a component of a modular space reactor by an orbital transfer vehicle (OTV), in accordance with an embodiment. While the assembly in FIG. 7 is illustrated as being performed by an OTV, other mechanisms such as robotic arms associated with a space station may be used instead to capture and assemble the modular space reactor of the present disclosure.

As shown in FIG. 7A, rocket 604, containing one of the components of a modular space reactor, is launched from an origination location 602. Then, as shown in FIG. 7B, a section 710 of a modular space reactor is released by rocket 604. An OTV 730 approaches section 710 as section 710 is released.

When the disassembled components of rocket 604 are at a safe distance away from section 710, as shown in FIG. 7C, OTV 730 performs proximity operations to approach section 710. OTV 730 then approaches section 710, as shown in FIG. 7D, then captures section 710 using robotic arms 735, as shown in FIG. 7E.

It is noted that while FIGS. 1-7 only show the reactor portion of embodiments of modular space reactors, the assembled reactors may be further configured to be attached to a spacecraft, a space station, a satellite, and other spaceborne objects requiring power. For instance, the modular space reactor of the present disclosure may be interfaced with a propulsion system to provide nuclear propulsion to a spacecraft. In another example, a spaceborne object may have integrated thereto a reactor housing, with which one or more disc sections, cylindrical sections, fuel tanks, and/or solid fuels may be inserted. In certain examples, the spent fuel sections or tanks may be replaced with newly launched sections or tanks in a modular manner.

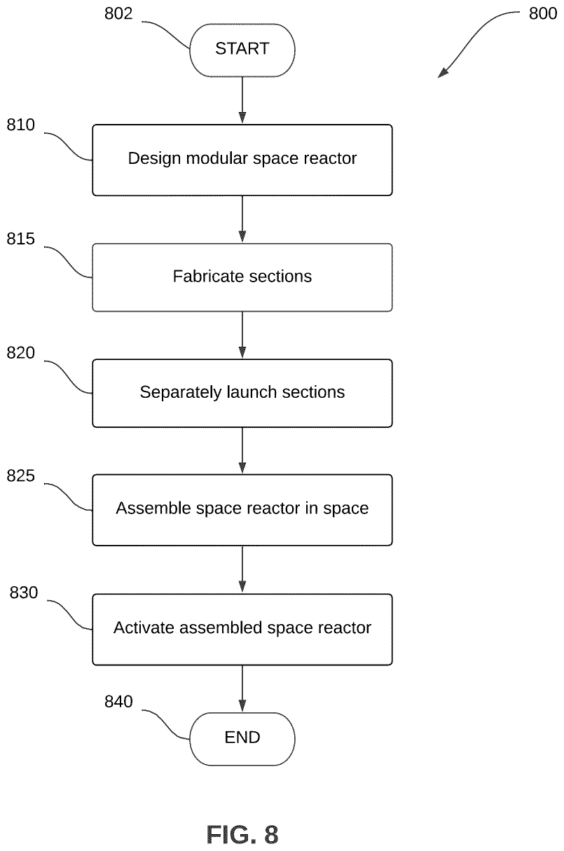

FIG. 8 shows a flow chart illustrating a process of using a modular space reactor, in accordance with an embodiment. As shown in FIG. 8, a process 800 begins with a start step 802, then proceeds to a step 810 to design a modular space reactor. For instance, step 810 may include taking into consideration the contents of each section of the modular space reactor, such as keeping any fuel contained therein to an amount less than required to sustain a fission chain reaction, ensuring the safe containment of the contents in each section, and providing interconnectivity within the sections to enable in-space assembly of the sections to form the assembled reactor.

Process 800 then proceeds to a step 815 to fabricate the sections, then a step 820 to separately launch the sections into space. Then, the sections are assembled together to form the modular space reactor in space in a step 825, then the assembled space reactor is activated in a step 830. Step 830 may include, for example, coupling the fuel-containing sections together to provide sufficient fuel to initiate and sustain a fission chain reaction in the assembled space reactor. Process 800 terminates in an end step 840.

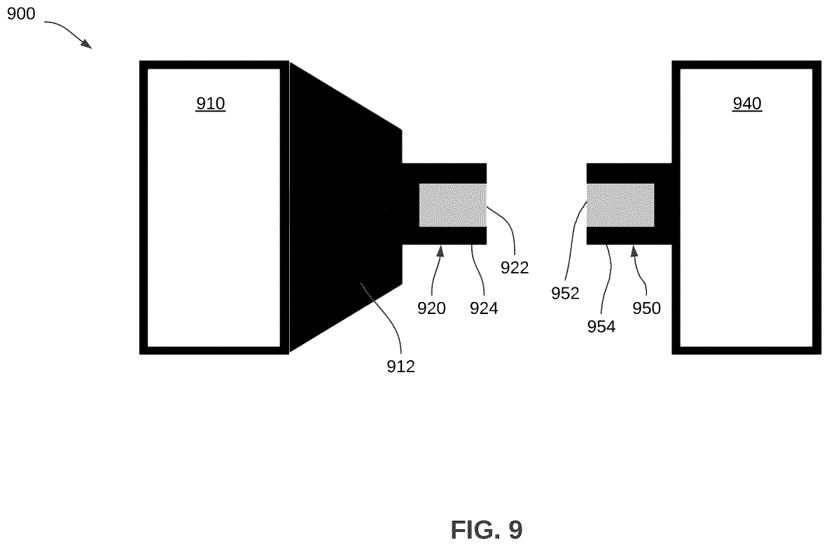

FIG. 9 shows a configuration 900, showing an exemplary configuration of the docking of two reactor portions. As shown in FIG. 9, a main spacecraft 910 may include a shield 912 for protecting main spacecraft 910 from radiation from the assembled reactor during reactor operation, as well as potentially harmful objects such as external sources of radiation or projectiles. Configuration 900 is shown to include a first reactor section 920, including a first core 922 and a first section shield 924. A delivery spacecraft 940 includes a second reactor section 950, including a second core 952 and a second section shield 954. Second reactor section 950 is configured to be compatible with first reactor section 920 such that the first and second reactor sections may be docked together with delivery spacecraft 940 performing proximity operations toward main spacecraft 910. Alternatively, second reactor section 950 may include its own navigation and propulsion systems (not shown) such that delivery spacecraft 940 may release second reactor section 950 near main spacecraft 910, and second reactor section 950 may rendezvous and dock with first reactor section 920 (or directly with main spacecraft 910 and/or shield 912 on its own power.

It is noted that the components shown in FIG. 9 are not shown to scale and may include additional or fewer components in embodiments. For instance, main spacecraft 910 may represent a portion of a much larger spaceborne object, such as a space station, and may or may not include a shield. Also, while main spacecraft 910 is shown to already have attached thereon the first reactor section, it may be configured instead to directly accept second reactor section thereon, without requiring the first reactor section. Other configurations may be contemplated and are considered a part of the present disclosure.

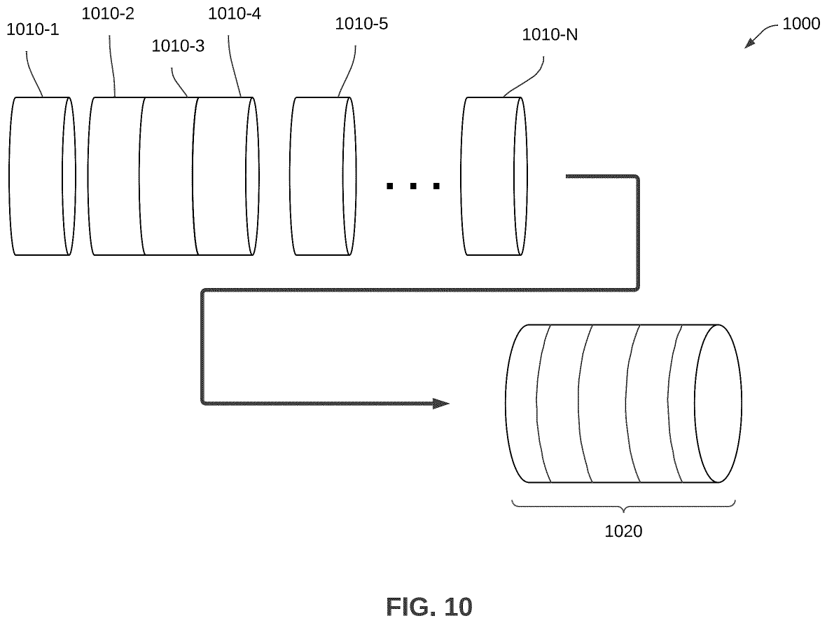

FIG. 10 shows another exemplary modular space reactor, in accordance with certain embodiments. As shown in FIG. 10, a schematic 1000 shows a plurality of disc sections 1010-1, 1010-2, 1010-3, 1010-4, 1010-5, . . . 1010-N, in a similar manner as schematic 100 of FIG. 1. As shown in FIG. 10, disc sections 1010-2, 1010-3, and 1010-4 are coupled together such that the combined disc sections 1010-2, 1010-3, and 1010-4 may be launched together on a single launch vehicle. For instance, each of disc sections 1010-2, 1010-3, and 1010-4 may include a different reactor component from each other, two of the disc sections containing the same reactor component, or each disc section containing the same reactor component. As an example, if each one of disc sections 1010-2 and 1010-4 contains a fuel rod, disc section 1010-3 may contain a shield or even simply air or vacuum to function essentially as a spacer to keep disc sections 1010-2 and 1010-4 spaced apart from each other. Then, the disc sections may be assembled together in space to form a modular space reactor 1020.

For any of the embodiments described above, reactor or fuel portions may be launched together on a single launch vehicle in a ride-share configuration as long as care is taken to keep the portions separated such that the portions will not be allowed to come together to form an inadvertent critical mass, even in the extremely unlikely case of a launch accident. Alternatively, as discussed above, the various components such as fuel or reactor portions may be launched on separate vehicles, thus eliminating the possibility of inadvertent critical mass. In embodiments, each reactor or fuel portion may include its own propulsive bus with rendezvous and docking capability for reaching the other fuel or reactor portions. In other embodiments, some of the reactor or fuel portions may be deployed from a launch vehicle in a passive configuration to be retrieved by a vehicle already in space. For instance, the spaceborne vehicle may be one or more OTVs shown in FIG. 7 for moving the fuel and/or reactor portion to a desired location, such as a reactor in the same or different orbit as the deployment location of the fuel or reactor portion. In other cases, the spaceborne vehicle may also itself include a reactor suitable for receiving fuel from the fuel or reactor portion describe above.

An additional advantage of the configurations described herein is the simplification of ground logistics prior to launch. By keeping the fuel and/or reactor sections separated on the ground prior to launch, the safety and handling requirements as well as logistics and regulatory burdens may be reduced in handling each fuel and/or reactor section. For instance, the safety requirements for nuclear regulatory commission licenses for storage, handling, and transportation may be significantly reduced, as each fuel and/or reactor section is incapable of itself reaching criticality. Therefore, keeping the fuel and/or reactor portions physically separated until assembly in space or on-orbit can greatly save time and cost of ground logistics, thus greatly increasing operational safety and efficiency on the ground.

The on-orbit assembly approach may also be applied to radioisotope sources as well as reactors. Some radioisotopes are extremely hazardous to launch due to their high radioactivity. For instance, in the case of a launch accident, the total effective dose (TED) to the general public may be unacceptably high, and currently the use of radioisotope-based systems are highly restricted. However, if the radioisotope sources are separated into smaller portions and launched separately, the maximum TED to the public may be limited even in the unlikely event of a launch accident. The various fuel and/or reactor portions may be launched in safe portions, then assembled in space in the manner described above, in certain embodiments.

The use of a modular space reactor may also facilitate the decommissioning or refueling of space-borne reactors. For instance, reactors for space vehicles may be refueled as needed in space, rather than having to be launched with sufficient fuel to last the vehicle's lifetime or the space vehicle being deemed space junk once it runs out of fuel. If a space reactor is designed in a modular fashion to be assembled and/or fueled in space, the space reactor may also be safely de-fueled or disassembled in in space for disposing spent fuel and/or replacing the fuel for continued operation.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding”—whether explicitly discussed or not—and, conversely, were there only disclosure of the act of “protruding”, such a disclosure should be understood to encompass disclosure of a “protrusion”. Such changes and alternative terms are to be understood to be explicitly included in the description.

1. A modular space reactor comprising:
a plurality of sections, each section containing a component of an assembled reactor,
wherein each one of the plurality of sections contains contents configured to be unable to sustain a fission chain reaction as an individual section,
wherein each one of the plurality of sections is configured to be separately launched into space from each other one of the plurality of sections,
wherein the plurality of sections are configured for assembly in space to form the assembled reactor, and
wherein the assembled reactor is configured for sustaining an active fission chain reaction only when all of the plurality of sections are assembled together.

2. The system of claim 1, wherein contents of at least one of the plurality of sections include at least one of fissile fuel, reactivity control devices, neutron reflectors, neutron moderators, radiation shielding mechanisms, cooling systems, power conversion systems.

3. The system of claim 1, wherein the plurality of sections are further configured for disassembly in space for being separable for at least one of refueling, decommissioning, and disposal of the system so disassembled.

4. A method for providing a space reactor, the method comprising:
designing a modular space reactor including a plurality of sections;
fabricating the plurality of sections;
separately launching into space each one of the plurality of sections from each other one of the plurality of sections;
assembling the plurality of sections in space to form the space reactor; and
activating the space reactor so assembled,
wherein each one of the plurality of sections is configured to be unable to individually sustain a fission chain reaction, and
wherein the space reactor is configured to be capable of sustaining an active fission chain reaction only when all of the plurality of sections are assembled together.

5. The method of claim 4, wherein assembling the plurality of sections in space includes performing at least one of automatic rendezvous, manual rendezvous, and proximity operations to bring together the plurality of sections.

6. The method of claim 4, wherein assembling the plurality of sections in space includes at least one of docking, robotic assembly, manual assembly by remote control from astronauts in space, and manual assembly physically by astronauts in space.

7. The method of claim 4, wherein assembling the plurality of sections in space includes coupling together at least one of electrical harnesses, fluid lines, gas connections, heat transfer structures, and additional equipment, devices, and structures associated with the reactor system.

8. A modular space reactor comprising:
a plurality of sections, each section containing a component of an assembled reactor,
wherein each one of the plurality of sections contains contents configured to be unable to sustain a radioactive chain reaction as an individual section,
wherein each one of the plurality of sections is configured to be separately launched into space from each other one of the plurality of sections,
wherein the plurality of sections are configured for assembly in space to form the assembled reactor, and
wherein the assembled reactor is configured for sustaining an active radioactive chain reaction only when all of the plurality of sections are assembled together.

9. The system of claim 8, wherein contents of each one of the plurality of sections include at least one of radioactive isotopes, reactivity control devices, neutron reflectors, neutron moderators, radiation shielding mechanisms, cooling systems, power conversion systems.

10. The system of claim 8, wherein the plurality of sections are further configured for disassembly in space for being separable for at least one of refueling, decommissioning, and disposal of the system so disassembled.

11. A method for providing a space reactor, the method comprising:
designing a modular space reactor including a plurality of sections;
fabricating the plurality of sections;
separately launching into space each one of the plurality of sections from each other one of the plurality of sections;
assembling the plurality of sections in space to form the space reactor; and
activating the space reactor so assembled,
wherein each one of the plurality of sections is configured to be unable to individually sustain a radioactive chain reaction, and
wherein the space reactor is configured to be capable of sustaining an active radioactive chain reaction only when all of the plurality of sections are assembled together.

12. The method of claim 11, wherein assembling the plurality of sections in space includes performing at least one of automatic rendezvous, manual rendezvous, and proximity operations to bring together the plurality of sections.

13. The method of claim 11, wherein assembling the plurality of sections in space includes at least one of docking, robotic assembly, manual assembly by remote control from astronauts in space, and manual assembly physically by astronauts in space.

14. The method of claim 11, wherein assembling the plurality of sections in space includes coupling together at least one of electrical harnesses, fluid lines, gas connections, heat transfer structures, and additional equipment, devices, and structures associated with the reactor system.
